(19) United States
(12) Patent Application Publication
(10) Pub. No.: US 2009/0149334 A1
(43) Pub. Date: Jun. 11, 2009

(54) METHODS AND APPARATUS FOR DETECTING LIQUID INSIDE INDIVIDUAL CHANNELS IN A MULTI-CHANNEL PLATE

(75) Inventors: Raymond Waterbury, Mirabel (CA); Daniel Seliskar, Montreal (CA); Robert Kearney, Montreal (CA); Eric Johnstone, Montreal (CA)

Correspondence Address: BERESKIN AND PARR, 40 KING STREET WEST, BOX 401, TORONTO, ON, M5H 3Y2, CA

(73) Assignee: McGill University, Montreal (CA)

(21) Appl. No.: 12/065,553

(22) PCT Filed: Sep. 1, 2006
(86) PCT No.: PCT/IB06/02391

§ 371 Date: Sep. 5, 2008

Related U.S. Application Data
(60) Provisional application No. 60/712,907, filed on Sep. 1, 2005.

(51) Int. Cl. C40B 30/00; C40B 60/12

(52) U.S. Cl. 506/7; 506/39

(57) ABSTRACT

There is provided a method of measuring properties of a liquid contained in individual wells inside a multi-well array, the method comprising steps of providing capacitor electrodes in the multi-well array, the electrodes adapted to detect a capacitance value of each one of the individual wells without interference of neighboring wells, measuring a capacitance inside each one of the individual wells, and using the capacitance measurements to calculate at least one property of the liquid contained in each one of the individual wells. There is further provided an apparatus for measuring properties of a liquid contained in individual wells inside a multi-well array, and a method of controlling quality of liquid handling task that is repeated across a set of individual wells inside a multi-well array.

### FIELD OF THE INVENTION

The invention relates to laboratory automation utilizing a multi-channel microplate format for liquid or liquid suspension sample processing.

### BACKGROUND OF THE INVENTION

Laboratory automation is essential for high-throughput research in systems biology and drug discovery. Many automated platforms exist for specific tasks and these are often employed for massive parallel liquid handling tasks such as assays, preparation, fractionation and purification. Most systems for high throughput sample screening and preparation, however, were created to eliminate workload bottlenecks and are simply open-loop control “extrapolations” of bench-scale methods, designed to perform a limited number of lengthy and repetitive tasks efficiently. As technology develops and scientific endeavors become larger in scope, there is an increasing demand for flexible, efficient and “smart” laboratory automation feedback systems for more reliable liquid handling for better results and data flow.

Capacitance based probe sensors are often used for liquid level sensing in high-throughput laboratory automation employing a microplate format for liquid handling. These sensors function by monitoring the capacitance between a probe and the liquid inside a microplate channel as the probe approaches or withdraws from the liquid. An abrupt change in the measured capacitance occurs at the surface of a conductive liquid, while thresholding is used for non-conducting solutions. Liquid volume is calculated from the position of the surface of the liquid.

Probe-sensors on high-throughput laboratory systems suffer from a number of important drawbacks. These sensors make contact with the liquid and depend on a positioning system to approach the individual channels of the microplate. The sensors are invasive, and the potential for the cross-contamination of samples precludes their use in protocols that employ a variety of different reagents or have downstream amplification steps such as bacteria inoculation and polymerase chain reactions. In addition, probe-based sensors have limited minimum-volume detection capabilities (>50 μl) because liquid volumes are calculated from the position of the liquid-surface as opposed to a volumetric-based measurement. Inter-probe and inter-vessel capacitance-based interference have also been reported, and error-checking schemes involving the deactivation of erratic probes have been proposed.

### SUMMARY OF THE INVENTION

This document describes a new device which has the potential to overcome limitations with current, probe-based capacitive sensors. Described herein is the proof-of-concept development of a prototype microvolume liquid-level sensor array that demonstrates the feasibility of building a mass-producible, non-contact sensor for quantitative monitoring of liquid and/or liquid suspension sample levels. The sensor array will provide on-line feedback to automated systems for quantitative, non-contact, closed-loop control of liquid samples, independent of a robotic positioning system and without the use of probe-based sensing components.

The fundamental concept underlying the operation of the sensor is that liquid-levels can be determined from the change in capacitance between a pair of electrodes integrated with the microplate geometry. Each sensor in the array contains an operationally-independent pair of electrodes embedded within an insulating wall. Dedicated capacitance transducers excite the electrode-pair of each sensor to measure its capacitance which is modulated by the volume of liquid inside the cavity. Liquid-levels are determined by successively exciting each sensor while the electrodes of adjacent sensors are held at ground to provide inter-sensor shielding.

A liquid-specific calibration procedure is used to adjust for different liquid permittivities and conductivities when the sensor is used to determine liquid-volumes. Moreover, a method of confirming the quality (e.g., occurrence, uniformity, progression, etc. . . . ) of a liquid handling task and a method of sensing chemical and biological reactions inside individual channels have been developed. Use of the device as a discrete liquid-level sensor for the determination of liquid presence/absence via thresholding is also described.

The capacitance-based microvolume liquid-level sensor array will allow for on-line feedback of liquid-level data to permit closed-loop control of liquid volumes on automated systems. This will allow for automated corrections of liquid-handling errors and the documentation of liquid-level data by automation host controllers. The sensor will enhance the functionality of microplates by offering a high level of automated stability for more sophisticated protocols to do preparations, processing, assays, manipulations, and reactions with no risk to the integrity of the samples under measurement.

A first object of the invention is to provide a method of measuring properties of a liquid contained in individual wells inside a multi-well array, the method comprising:
providing capacitor electrodes in the multi-well array, the electrodes adapted to detect a capacitance value of each one of the individual wells without interference of neighboring wells;
measuring a capacitance inside each one of the individual wells; and
using the capacitance measurements to calculate at least one property of the liquid contained in each one of the individual wells.

The capacitor electrodes can be rectangular-shaped. If it is the case, the interference shielding of neighboring wells is carried out by connecting electrodes of the neighboring wells to ground or to common.

The interference shielding of neighboring wells can also be carried out by using curve-shaped capacitor electrodes, where the capacitor electrodes enclose partially around the individual wells.

The measuring preferably comprises measuring calibration parameters of the individual wells. The measuring calibration parameters preferably comprises measuring capacitance values of a given individual well at two different liquid volumes. The two different liquid volumes are preferably when the given individual well is empty and when the given individual well is full with the liquid.

The property can be a volume of the liquid inside the individual wells, and the capacitance measuring is carried out using at least one of a dielectric constant and a conductivity of the liquid.

The property can also be a state of presence of the liquid inside the individual wells. The property can also be a state of presence of a liquid chemical or biological reaction, and then, the measuring comprises measuring over time a value change in at least one of a dielectric constant and a conductivity of the liquid.

The property can further be a change of volume of the liquid inside the individual wells, and, the capacitance measuring is carried out using at least one of a dielectric constant and a conductivity of the liquid.

The capacitor electrodes can be ring electrodes, the measuring capacitance comprises measuring the capacitance during handling the liquid inside the individual wells and, during the handling, detecting at least one predetermined level between the ring electrodes when the capacitance reaches a threshold value.

Another object of the present invention is to provide a method of controlling quality of liquid handling task that is repeated across a set of individual wells inside a multi-well array, the method comprising:
performing a liquid handling task in at least two of the individual wells;
measuring capacitance of the at least two of the individual wells;
comparing the capacitance measurements to determine whether or not the measurements are consistent; and
using results of the comparison to determine whether or not the liquid handling task is consistent across the set of individual wells.

A further object of the present invention is to provide an apparatus for measuring properties of a liquid contained in individual wells inside a multi-well array, the apparatus comprising:
an array of individual wells;
a set of operationally-independent capacitive sensors having capacitor electrodes shielding the individual wells; and
a capacitance-transducer to measure a capacitance of the individual wells.

Each one of the individual wells is preferably insulated with an insulating wall of a non-conductive bulk material.

As already mentioned, the capacitor electrodes can be rectangular-shaped plates and are designed to be connected to ground or to common to provide shielding. The capacitor electrodes can also be curve-shaped plates and enclose partially around the individual wells to provide shielding. The capacitor electrodes can also be ring electrodes. Besides, the capacitor electrodes can be continuous across the array of individual wells.

The multi-well array is preferably two-dimensional and consists of a multi-well plate. It can also be one-dimensional.

The apparatus preferably further comprises:
a multiplexer connected to each one of the individual wells and to the transducer to respectively take control of a given individual well among the individual wells and to connect the given individual well to the capacitance-transducer to measure a capacitance of the given individual well; and
a control circuit connected to the multiplexer and to the capacitance-transducer to respectively transmit a control signal to the multiplexer to select the given individual well and to receive the capacitance value of the given individual well from the capacitive-transducer.

The capacitive sensors, the capacitive-transducer, the multiplexer and the control circuit are preferably implemented on a single printed circuit board (PCB) yielding a compact design. The PCB is preferably constituted of four layers.

### BRIEF DESCRIPTION OF THE DRAWINGS

FIG. 1: Schematic of host controller, capacitance transducers and sensor electrode configuration.

FIGS. 2A and B: A) Schematic of non-invasive capacitive sensor and B) associated electrical model for a fluid-filled tube. A parallel combination of Cₗ and 1/Rₗ model the capacitance and the conductivity of the fluid while C_{w} models the effective capacitance of the insulating tube wall.

FIGS. 3A, B, C, D, E and F: Development of an electrical model of the sensor based on parallel-plate approximations of major regions: A) cross-sectional representation of parallel-plate approximation of the non-invasive capacitive sensor, B) equivalent cross-section, C) equivalent cross-section when fringing at air/liquid interface is neglected, D) equivalent model using electrical parameters, and E) electrical model of the sensor as a function of liquid volume and conductivity with the addition of C₀ to account for fringe fields. Rₐ and R_{w} are very large and can be neglected.

FIGS. 4A and B: A) Cross-sectional geometry of a non-invasive liquid-level sensor of height H and, B) a parallel-plate system approximating its geometry.

FIG. 5: Wiring diagram for interfacing QT300 transducers to sensor electrodes and a host controller (adapted from QT300 datasheet).

FIG. 6: Block-diagram schematic of a representative setup for validating/operating the sensor array.

FIG. 7: Schematic of sources of capacitance contributing to the overall capacitance measured by the charge-transfer transducer.

FIG. 8: Capacitance of the center sensor of the PCB-based sensor prototype for different liquids. Enlarged points denote measurements made at volumes designated as the “empty” and “full” levels of the sensor; solid vertical lines indicate volumes at the endpoints of the electrodes; dashed vertical lines indicate volumes at the level of the EMI shields. Volumes are referenced to the bottom of the electrodes. Note that the offset observed between the group of NaCl solutions and the ethanol solutions (obvious at the −100 μl volume level) is attributed to the disassembly and subsequent re-assembly of the sensor array between tests.

FIG. 9: Schematic of a sensor array design comprising sets of continuous-electrodes.

FIG. 10: Schematic of active sensors shielded by inactive sensors with grounded electrodes.

FIG. 11: Schematic of use of a stray-immune transducer for liquid-level sensing in an array with independent and individually-addressable electrodes. Routing is shown for the active sensor only; every electrode in the array is held at grounded.

### DETAILED DESCRIPTION OF THE INVENTION

### 1 Overview of Sensor Array

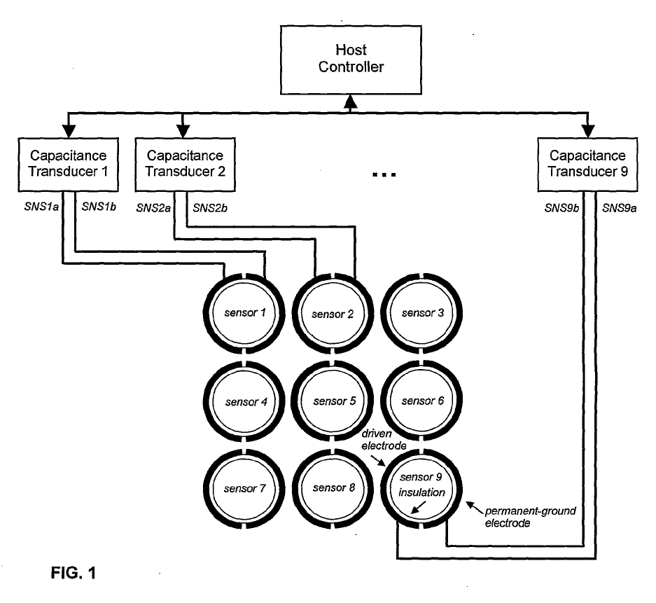

The operating principle of the microvolume capacitive liquid-level sensor array is that liquid-level is determined via the change in effective capacitance of an electrode-pair similar to a parallel-plate capacitor. Each sensor in the array contains an operationally-independent pair of electrodes embedded within an insulating wall (see FIG. 1). Dedicated capacitance transducers excite the electrode-pair of each sensor to measure its effective capacitance that is modulated by the volume of liquid inside its cavity.

The capacitive sensors each consist of two electrodes: a “driven” electrode (SNSa) and a “permanent-ground” electrode (SNSb). The driven electrode of a sensor is subject to the excitation voltages of a capacitance transducer when the sensor is active, while the permanent-ground electrode is always connected to the circuit ground. The permanent-ground electrodes are continuous from one sensor to the next; they are also connected to the EMI shields that surround the array.

Each sensor is restricted to one of two possible states: “active” or “inactive” (default). In the active state, the driven electrode is excited by the transducer to measure the effective capacitance between itself and ground. In the inactive state, the transducer temporarily connects the driven electrode to ground. This causes the contents of inactive sensors to be electrically-imperceptible to neighboring sensors, and is the mechanism through which inter-sensor EMI shielding is achieved. A host controller ensures that a single sensor is active at any time to prevent sensor-to-sensor crosstalk.

### 1.1 Sensor Capacitance

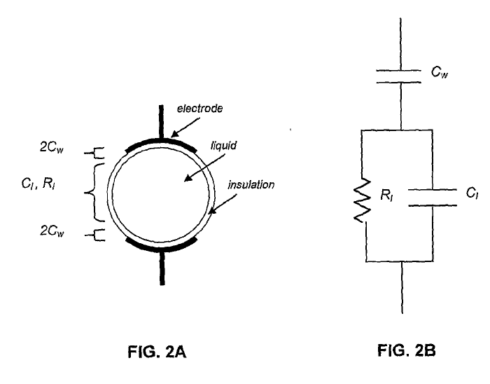

The electrical model of a non-invasive measurement of capacitance of a liquid for cross-sectional investigations of a tube has been reported and is shown in FIG. 2. The model parameters are:
C_{w} the capacitance of the insulating wall,
Cₗ the capacitance of the liquid and,
Rₗ the resistance of the liquid.

A parallel combination of Cₗ and 1/Rₗ is used to model the capacitance and the conductance of the fluid in the channel, in series with C_{w}, which models the capacitance of the insulating wall (see FIG. 2).

The existing model for the non-invasive measurement of capacitance within a tube can be adapted to account for the effect of variable liquid-levels in the microvolume liquid-level sensor array. It comprises two instances of the existing model connected in parallel, and includes a liquid-level factor corresponding to the location of the liquid/air interface along the height of the sensor. The extended model describes the non-invasive measurement of a partially-filled tube whose liquid-level is variable between the endpoints of the cylinder.

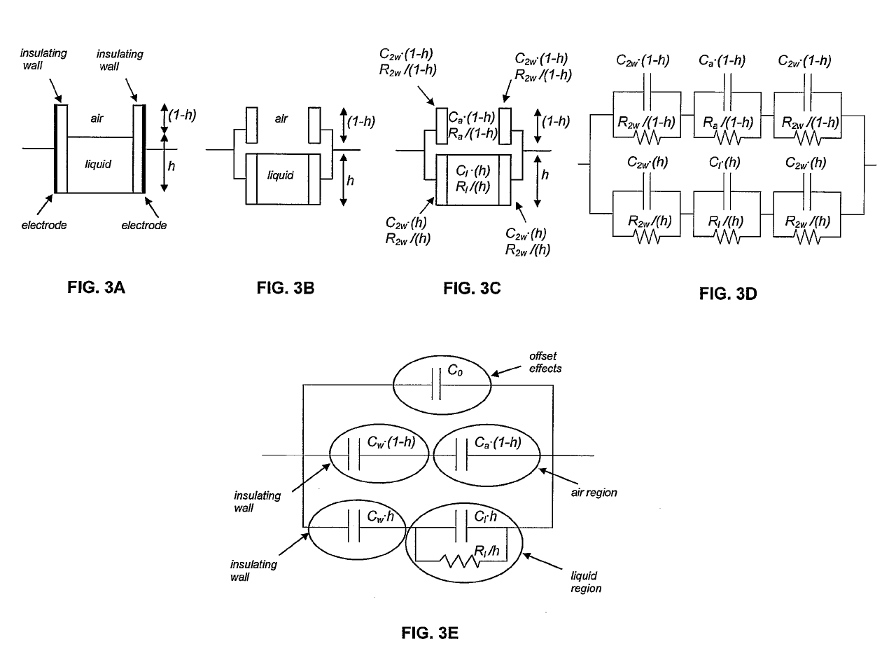

The liquid-level dependent model can be rationalized using a series of schematics where a partially-filled, tube-shaped, non-invasive capacitive sensor is described in terms of its electrical parameters. FIG. 3 illustrates the procedure.

FIG. 3A shows a side-view of an analogous, parallel-plate capacitive sensor with rectangular-shaped electrodes in place of the curved-plate electrodes of the tube-shaped sensor. This geometry is conceptually simpler and retains the operationally-relevant characteristics of the curved-plate sensor: air, liquid and insulating regions, air/liquid interface, the liquid-height factor h, and uniform electrodes of finite-length.

The sensor has a variable fill-state given by a liquid-height factor, 0≦h≦1, normalized to the height of the tube, H. A portion of the total electric-field generated by the active electrode, the “internal fields”, penetrate the insulating wall of the non-conductive insulation, the interior of the cylinder (including any liquid therein) and a second insulating wall to terminate on the opposing electrode of the sensor.

FIG. 3B shows the model partitioned at the liquid/air interface to produce a two-branch model of homogenous regions. The “liquid-branch” consists of the liquid region and two insulator regions representing the portion of the insulation in contact with the liquid. The second branch, the “air-branch”, is analogous to the first; it represents the air column above the liquid and the adjacent insulation.

FIG. 3C shows the assignment of electrical parameters to the air, liquid and four insulator regions of the model, each of which is modeled as an independent, homogeneous, parallel-plate subsystem. These electrical parameters depend on the geometric and material properties of each region; resistance depends on conductivity and capacitance on permittivity.

FIG. 3C also illustrates how liquid-volume modulates the geometry of the regions by changing the height of the parallel-plate subsystems in each branch. Note that the regions within a same branch experience an identical change in the height of their electrodes while those in the second branch undergo an opposite change. Further, it is known that the capacitance of a parallel-plate system is proportional to its height and that its resistance varies in inverse proportion. The capacitors and resistors of the liquid-branch are therefore weighted by h and 1/h, respectively, while the parameters of the air-branch are weighted by (1−h) and 1/(1−h). Applying the weighting factors to the resistance and the capacitance of each region yields:
Rₗ/h, the resistance of the liquid,
Cₗh, the capacitance of the liquid,
R_{w}/h, the resistance of the portion of insulation at the level of the liquid, and
C_{w}h, the capacitance of the portion of insulation at the level of the liquid,
   for the liquid-branch. The parameters of the air-branch are:
Rₐ/(1−h), the resistance of the air,
Cₐ(1−h), the capacitance of the air,
R_{w}/(1−h), the resistance of the portion of insulation at the level of the air, and
C_{w}(1−h), the capacitance of the portion of insulation at the level of the air.

FIG. 3D shows the corresponding two-branch electrical circuit having an identical parameter set. Each region is modeled using a parallel RC-circuit.

FIG. 3E shows a simplified circuit for the electrical model. The resistances of the air and insulator regions are extremely large, so Rₐ and R_{w} can be dropped from the circuit. Next, the two capacitors modeling the insulators in each branch are combined into a single equivalent capacitor, C_{w}. An additional constant capacitor, C₀, is also incorporated to model DC offsets due to fringe-fields, field distortions or ground-shield effects. These effects, modeled by the “offset-branch,” are approximately constant.

The resulting circuit is a simple, lumped-parameter electrical model describing a non-invasive, capacitance-based liquid-level sensor in terms of the resistance and capacitance of the air, the liquid and the insulator. The model assumes a two-electrode system where large, insulated electrodes produce an electric field that is roughly perpendicular to the surface of the liquid. A second assumption is that the height of the liquid-level, h, is proportional to liquid-volume. These conditions are true for both the parallel-plate geometry and the curved-plate electrode configuration upon which the microvolume liquid-level sensor array is based.

The model indicates that, for every liquid, the relative sizes of the model parameters are constant within their respective branch, and the relative contributions to the overall circuit behavior shifts, linearly, from the (1−h)-weighted branch to the (h)-weighted branch as a channel fills with liquid (the contribution from the third branch is constant). This suggests the possibility for capacitance-based transduction of liquid volumes.

### 1.2 Design Strategy

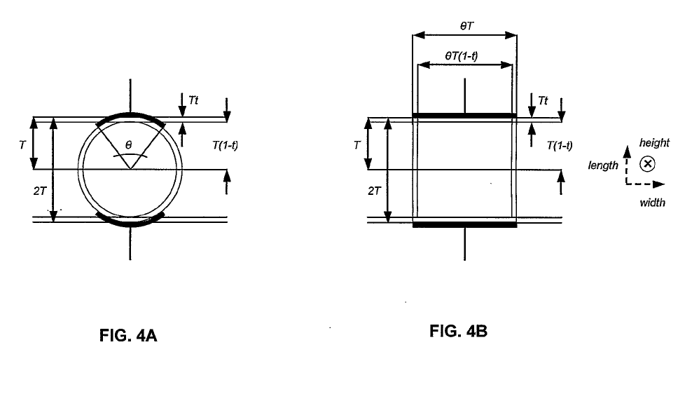

The components of the electrical model may be estimated in terms of geometric and material parameters by approximating the various regions of the sensor regions as parallel-plate subsystems. The approximation is shown in FIG. 4.

The length of the parallel-plate sensor, 2T, is equal the diameter of the curved-plate sensor, while the width of the parallel-plate electrodes is equal to the breadth of the electrodes in the curve-plate system, Tθ. A normalized insulation thickness, t, is incorporated in the model to account for the tradeoff between the insulation thickness, tT, and the length of the cavity T(1−t). Values for the electrical parameters of the sensor are given by:

$$\begin{matrix}{C}_{a} = \frac{{ɛ}_{0} {ɛ}_{a} θ T ( 1 - t ) H}{2 T ( 1 - t )} = \frac{{ɛ}_{0} {ɛ}_{a} θ H}{2} & Equation 1 A \\ {C}_{w} = \frac{1}{2} \cdot \frac{{ɛ}_{0} {ɛ}_{w} θ TH}{Tt} = \frac{{ɛ}_{0} {ɛ}_{w} θ H}{2 Tt} & Equation 1 B \\ {C}_{l} = \frac{{ɛ}_{0} {ɛ}_{l} θ T ( 1 - t ) H}{2 T ( 1 - t )} = \frac{{ɛ}_{0} {ɛ}_{l} θ H}{2} & Equation 1 C \\ {R}_{l} = \frac{2 T ( 1 - t )}{{σ}_{l} θ T ( 1 - t ) H} = \frac{2}{{σ}_{l} θ H} & Equation 1 D\end{matrix}$$

where
∈₀ is the permittivity of free space,
∈_{w} is the relative permittivity of the insulation,
∈ₐ is the relative permittivity of air,
∈ₗ is the relative permittivity of the liquid,
σₗ is the conductivity (1/resistivity) of the liquid,
H is the height of the electrodes,
T is the radius (length) of the cavity measured from the inside face of the curved-plate (parallel-plate) electrode-pairs,
θ is the angle (0<θ<π) subtended by the curved-plate electrodes, and
t is the insulation thickness normalized to T.

C_{w} is the equivalent capacitance of the capacitors modeling the insulating wall, Cₐ is the capacitance of the air region of an empty channel, and, Cₗ and Rₗ are the capacitance and resistance of the liquid of a full channel. The parallel-plate approximation allows for estimates of the electrical parameters and provides qualitative insight into how the geometric and material parameters affect the performance of the sensor. For example, a “typical” sensor with ∈_{w}=2.1, H=0.01 m, t=0.35, θ=π and arbitrary T will have

$${C}_{a} = \frac{{ɛ}_{0} {ɛ}_{a} θ H}{2} = 0.139 pF$$

$$and$$

$${C}_{w} = \frac{{ɛ}_{0} {ɛ}_{w} θ H}{2 t} = 0.834 pF .$$

Cₗ varies with the relative permittivity of the liquid in the sensor; for a low-permittivity liquid (ethanol, ∈ₗ=25.3)

$${C}_{l} = \frac{{ɛ}_{0} {ɛ}_{l} θ H}{2} = 3.519 pF ,$$

and for a high-permittivity liquid (distilled water, ∈ₗ=78.4)

$${C}_{l} = \frac{{ɛ}_{0} {ɛ}_{l} θ H}{2} = 10.904 pF .$$

The resistance of the liquid, Rₗ, varies with its conductivity; for a low-conductivity liquid (distilled water, σₗ=5.50'10⁻⁶)

$${R}_{l} = \frac{2}{{σ}_{l} θ H} = 11.6 M Ω ,$$

and for a high-conductivity liquid (IM NaCl solution σₗ=13.72)

$${R}_{l} = \frac{2}{{σ}_{l} θ H} = 17.1 Ω .$$

C₀ models sources of baseline capacitance and is assumed to be constant. Its value cannot be estimated using the parallel-plate model.

Due to the relative sizes of Cₐ, C_{w} and Cₗ, the electrical behavior of the air-branch is determined mostly by Cₐ, while that of the liquid-branch is dominated by C_{w} (see FIG. 3E). The capacitance of the sensor therefore varies from ˜(Cₐ+C₀) to ˜(C_{w}+C₀) as the sensor fills with liquid.

In the preceding example, C_{w}>Cₐ because the insulation was relatively thin and had a higher relative permittivity compared to the air-filled cavity. The relative size of C_{w} and Cₐ are independent of liquid properties, and the admittance of the air-branch will vary only with liquid-level h. However, the relative sizes of Cₗ, Rₗ and C_{w} in the liquid-branch will vary with the liquid depending on its physical properties. The importance of these differences is reduced by using a relatively thick insulation with a low dielectric constant so that C_{w} dominates the behavior of the branch; sensitivity to liquid-specific properties (permittivity and conductivity) is therefore reduced by design. In addition, a liquid-specific calibration procedure is employed to ensure accurate volume measurements across different liquids (see Section 3.1). Thus, while calibration techniques are used to adjust for initial liquid properties (permittivity and conductance), a careful design strategy is employed to reduce the prototype's sensitivity to these parameters as much possible.

In the case of non-conductive liquids the capacitive effects predicted by the individual branches are additive and the channel capacitance is given by Equation 2.

$${C}_{x} = ( \frac{{C}_{w} {C}_{l}}{{C}_{w} + {C}_{l}} ) h + ( \frac{{C}_{w} {C}_{a}}{{C}_{w} + {C}_{a}} ) ( 1 - h ) + {C}_{0} \qquad Equation 2$$

The measured capacitance is linear with fluid level h, and varies from C_{w}Cₐ/(C_{w}+Cₐ)+C₀ when empty to C_{w}Cₗ/(C_{w}+Cₗ)+C₀ when full. Different liquids will have different permittivity, and therefore, different values for Cₗ; channel capacitance is a linear function of volume, but its slope is liquid-dependent.

In addition, conductive liquids will have a significant shunting resistance, Rₗ/h, causing the liquid to behave like an RC circuit which continuously discharges Cₗ. This may be accounted for by the use of a capacitance transducer that maintains a highly-linear transduction of measured capacitance and/or a compensatory calibration procedure (see Section 3.1) where necessary.

### 1.3 Electrode Construction

The electrodes, sensor insulation and transducer electronics are implemented on a four-layer printed-circuit-board (PCB) yielding a compact design that minimizes the distance between the electrodes and the electronics. Uniform electrode pairs are implemented by connecting parallel, copper-plated through-holes into groups that function as the sensor's electrodes. The design permits good control of design parameters and a high-quality, robust construction that is appropriate for mass fabrication methods. It also allows for the sensor electrodes, control circuit and transducer electronics to be designed as part of a single PCB. EMI shielding from the external environment is implemented using ground-plane PCB layers that are connected to the top and bottom layers of the multilayer board design; channel-to-channel shielding is achieved by grounding the electrodes of inactive sensors.

The 3×3 prototype sensor array confirms the feasibility of building a mass-producible liquid-level sensor array for non-contact liquid-level sensing in a standard microplate geometry. The sensor electrodes, electrode-insulation, transducer circuit, electrical interconnects and cable port are integrated on a 147 mm×108 mm×8.2 mm four-layer PCB. The sensor array includes nine non-plated 6.35 mm (250 mil) diameter holes drilled on 9 mm (354 mil) centers corresponding to the channel-spacing of a standard 96-channel microplate. Electrode-pairs are implemented by connecting twenty-four 0.5 mm (20 mil) diameter copper-plated through-holes into groups of twelve such that each group functioned as an electrode of the sensor. The plated-holes are equally spaced on the circumference of a 7.87 mm (310 mil) diameter circle co-centric with the non-plated holes; the inter-hole spacing of the plated holes was 0.5 mm (21 mil) at the closest points. The distance from the plated holes to the cavities of the sensor (6.35 mm non-plated holes) is also 0.5 mm (20 mil) at the closest points. The bulk of the PCB may be made of FR4 (∈ᵣ≈4.2) filler material which insulates the electrodes from the interior of the cavity and provides mechanical stability. The sensors have electrode-height H=8.2 mm, sensor radius T=3.7 mm (145 mil), normalized insulation thickness t=0.35 and electrode breadth θ=π.

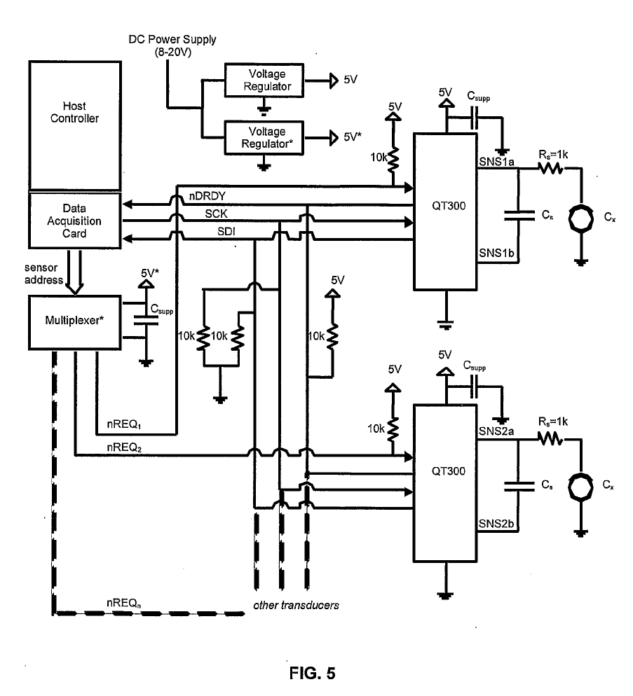

FIG. 5 shows how electrode-pairs are interfaced to dedicated QT300 transducers residing on the same PCB, and configured with Cₛ=470 nF and Rₛ=1 k. The transducers share SPI control signals nDRDY, SDI and SCK, but have separate nREQ request lines for selective triggering of the sensors in the array. Inactive QT300's float their respective SPI pins, allowing lines to be shared across multiple transducers; pull-up/pull-down resistors force the lines to high/low idling voltages when no transducer is active. Lines nREQ₁ through nREQ₉ are connected to the output of a multiplexer propagating the nREQ sensor-activation signal from the host controller based on a 4-bit address generated by the host controller. A single sensor is therefore active at any time. The PCB-sensor array prototype includes a cable port for interfacing to the host controller by means of a data acquisition card.

Sensors are shielded from the external environment by a pair of removable, single-layer 39 mm×62 mm×1.6 mm ground-plane PCBs connected to the top and bottom layer of the four-layer PCB, centered on the electrodes (not shown). The shields are connected to the four-layer board using two copper-plated screw-holes that also provide ground-continuity to the shields. The copper pours on the shields may be relieved in areas resting above/below the location of the SNS1 traces on the 4-layer board to reduce the baseline capacitance. These areas may be hatched by copper traces that may be optionally connected to the ground-plane using a switch. This provides for the flexibility of EMI shielding in proximity to the SNS1 traces at the expense of an increase in the baseline capacitance of the sensors.

It will be appreciated that many other conceptually-equivalent methods exist for implementing the various components of the sensor and that the above description is not meant to list all possible embodiments of the invention.

### 2 Equipment Setup

As shown in FIG. 1, each sensor is interfaced to its own, dedicated capacitance transducer. The host controller (laptop) is used to coordinate the operation of the set of transducers; it dictates which sensor to activate and ensures that the sensors activate sequentially to avoid sensor-to-sensor crosstalk.

### 2.1 Experimental Setup

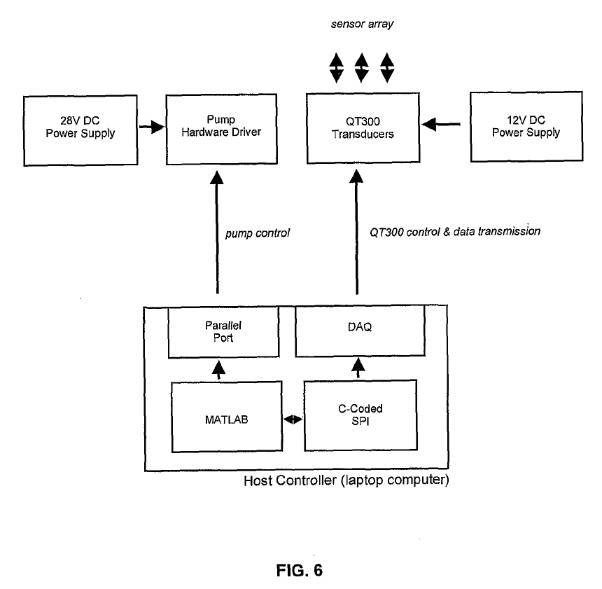

FIG. 6 is a block-diagram schematic of a representative setup for validating/operating the sensor array. System control and data acquisition are performed using a laptop computer running Matlab 7.0 Data Acquisition Toolbox and a National Instrument DAQCard-AI-16E-4 PCMCIA card. A variable-volume stepper pump (LPVX0502200BB Lee stepper pump, Lee Co.) supplies liquid to the individual sensors which are fitted with non-conductive tubes to contain the liquid for testing the sensor. A stepper pump hardware driver (2035 Step Motor Driver, Servo Systems Co.) powered from a 28V DC power supply (HC28-2-A, Condor) controls the pump.

Separate QT300 transducers (QT300, Quantum Research Group Ltd, UK) are used to measure the capacitance of each sensor and are integrated with the PCB. The transducers were powered by 5V DC (down-regulated from a 12V supply) and interfaced to the host controller through the data acquisition card. The transducers include SPI ports for interfacing with the host controller and control lines for sample-on-demand operation. A C-code data transfer routine is used to control and to implement SPI communication with the transducer.

It will be appreciated that many other conceptually-equivalent setup configurations are possible. Stepper pump and tubing are not required for implementing the sensor in final applications.

### 2.2 Capacitance Transduction

A commercial charge-transfer capacitance transducer (QT300, Quantum Research Group, UK) excites the liquid-level sensors. This transducer was selected for its: (1) low sensitivity to liquid conductivity, (2) transduction of capacitance in proportion to liquid-level, (3) ability to resolve small changes in capacitance on top of a large baseline capacitance, and (4) availability as an integrated circuit (IC).

A separate QT300 is connected to the electrodes of each sensor to measure its effective capacitance, Cₘ. The transducer charges Cₘ and then transfers this charge to a charge-integrating capacitor, Cₛ. This cycle repeats many times to build-up the voltage across Cₛ, and terminates when a threshold voltage Vₜₕ is reached. The number of cycles, n, needed to charge Cₛ is the raw data. The raw data is converted to measured capacitance, Cₘ, using

$${C}_{m} = k \frac{{C}_{s}}{n} \qquad Equation 3$$

where k=0.51 is a constant related to fixed parameters internal to the QT300.

It will be appreciated that a number of different capacitance transducers may be used in lieu of the QT300 charge-transfer capacitance transducer (see Section 4.4).

### 2.3 Measured Capacitance

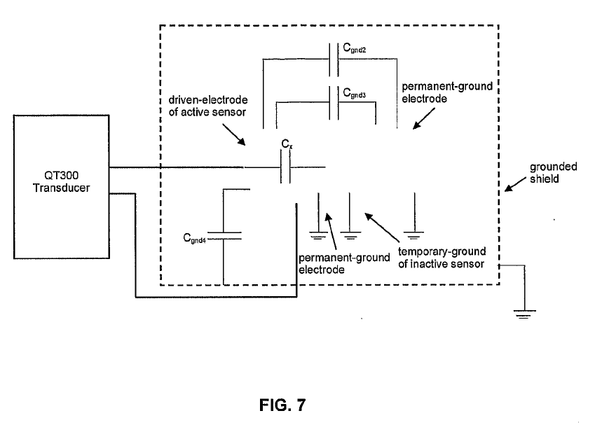

The QT300 capacitance transducer measures the effective capacitance between the driven electrode of the active sensor in the array and ground (see FIG. 7). This is the summation of the capacitance between the driven electrode of the active sensor and:
1. the opposite, permanent-ground electrode of the active sensor, Cₓ,
2. the permanent-ground electrode of neighboring inactive sensors, C_{gnd2},
3. the driven electrode of neighboring inactive sensors (temporarily grounded), C_{gnd3}, and
4. the permanently grounded EMI shields, C_{gnd4}.

### Thus,

Cₘ=Cₓ+C_{gnd2}+C_{gnd3}+C_{gnd4}. Equation 4

The first component, Cₓ, modulates the overall capacitance in proportion to liquid-level and is the portion of the measured capacitance corresponding to the model described in Section 1.2. Components C_{gnd2}, C_{gnd3} and C_{gnd4} are constants; these are equivalent to an offset in the baseline capacitance and can be absorbed into the offset component of the model, Co. It will be recognized that further improvements to the performance of the sensor are possible through the use of alternate transducers (see Section 4.4).

### 3 Sensing Applications

The liquid-level sensor array lends itself to a variety of sensing applications in addition to the transduction of liquid volumes. A brief description of various sensing applications is provided in the following sections.

### 3.1 Liquid Level Determination and Sensor Calibration

A sensor calibration procedure is required for the transduction of liquid volumes. Assuming a second-order relationship between measured capacitance and liquid-volume, convenient calibration points are the capacitance of an empty-channel, C_{empty}, and a filled-channel, C_{full}. The fill percentage is then given by the change in capacitance relative to C_{empty} over the full range change in capacitance, (C_{full}−C_{empty}):

$$\% full = 100 \cdot \frac{{C}_{measured} - {C}_{empty}}{{C}_{full} - {C}_{empty}} . \qquad Equation 5$$

The host controller stores calibration data and calculates the fill volume. The calibration is performed for each sensor in the array and for every liquid; it compensates for different liquid conductivities and permittivities, and inter-sensor construction differences introduced at the fabrication stage. Note that the present implementation assumes that the conductivity and permittivity of the liquid remain constant post-calibration.

The minimum number of required calibration points is equal to the order of the assumed relationship between capacitance and liquid-volume system. Higher-order polynomials may be used instead of a linear model to compensate for non-linearities between the measured capacitance and actual liquid-volume (e.g., a second-order polynomial may be used to compensate for a non-linearity caused by fringe-field effects near the endpoints of the electrodes).

The need to repeat calibration measurement for each individual sensor may be circumvented if construction tolerances are such that inter-sensor variations in baseline capacitance (C_{empty}) and/or the inter-sensor variations in the relationship between capacitance and liquid-volume are sufficiently small. For example, the baseline capacitance, C_{empty}, need not be measured for each sensor if construction tolerances are small enough such that inter-sensor variations in C_{empty} are negligible.

It is also feasible to characterize the relationship between measured capacitance and liquid permittivity and/or conductivity to eliminate the need to repeat calibration measurements for each liquid type. Calibration points may conceivably be extrapolated from measurements made on a representative “stock” solution.

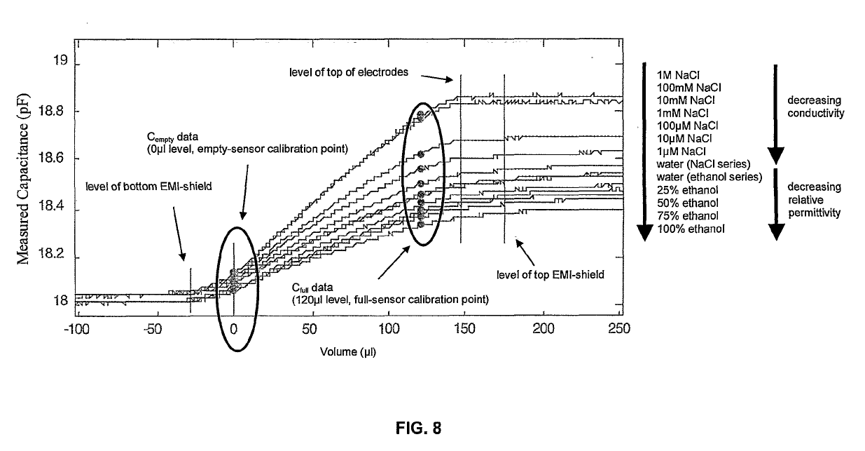

The liquid-level sensing capability of the sensors was tested using NaCl and ethanol solutions of different concentrations to simulate a range of conductivity and permittivity typical in biological and chemical research. FIG. 8 shows the measured capacitance for the set of test solutions.

### 3.2 Discrete Liquid-Level Sensor

The sensor array may be used as a discrete liquid and/or sample sensor to monitor for the presence/absence of a minimum quantity of liquid in each sensor. This would be achieved by verifying that the capacitance of the sensor is above/below some threshold value. Note that liquid-specific calibration is unnecessary; the threshold value is simply selected to accommodate a particular set of solutions. For example, a threshold value of 18.3 pF on the center sensor of the PCB-based array would confirm the presence of a minimum of 25 μl of liquid inside the sensor for all test liquids (see FIG. 8).

The threshold of each sensor may be selected as some value (C_{margin}) above the measured baseline capacitance (C_{empty}) of each sensor; i.e., C_{threshold}=C_{empty}+C_{margin} where C_{margin} is constant across sensors. A universal threshold is also feasible when inter-sensor variations in the baseline capacitance are sufficiently small, thus eliminating the need to measure C_{empty} for each sensor. No hardware modifications are required.

### 3.3 Control by Comparison

The sensor also provides the capability to monitor for the uniformity or progression of liquid-handling tasks, and/or certain biological processes and chemical reactions across a set of sensors. This would be achieved by comparing the change in the measured capacitance caused by changes in liquid volume, permittivity or conductivity. Note that this application does not require a calibration since it is based on the comparison of capacitance measurements made before and after a monitored event is assumed to have occurred. This application, however, is not applicable in situations where simultaneous changes in multiple parameters could lead to a zero net change in the measured capacitance (e.g., a chemical reaction causing an increase in the relative permittivity of a liquid accompanied by a decrease in conductivity). Potential applications include:
1. Cell (population) growth
2. Production, secretion or over expression of biological molecules
3. Cell disruption or cell lysis
4. Biological and chemical reaction

Similarly, the sensor would be able to detect processes that alter any one of the volume, permittivity or conductivity of the sample within the channel.

### 4 Alternate Designs and Modifications

A number of different design modifications could be implemented on the liquid-level sensor to accommodate construction capabilities, improve performance or reduce the hardware requirements. Some examples are provided in the following sections.

### 4.1 Arbitrarily-Shaped Electrodes

The geometry of the sensor electrodes is highly flexible. Helical, triangular, disc, ring-shaped electrodes, multi-electrode and continuous-electrode designs (where electrodes are continuous across channels) are possible with appropriate transducers and calibration. Important criteria are that electrodes be insulated from the liquid and that some portion of the electric-fields penetrates the interior region of the sensor cavity. In most cases, the capacitance will not be a linear function of liquid volume and a calibration will be necessary to identify the relationship between the measured capacitance and the liquid-level for determining liquid volume (see Section 3.1).

For example, it is possible to modify the shape of the electrodes of the capacitive microvolume sensor array to a ring-based design where the diameter of each ring is larger than the diameter of the channel. For each sensor, the two rings are positioned co-centric with the channel and are stacked one atop the other with a small, insulated spacing in between. When the electrode-pairs are excited, curved fringe-fields penetrate the interior region of the channel. The presence or absence of liquid in the channel modulates the measured capacitance by means of the fringe fields. This modulation is non-linear, but monotonic with liquid volume; liquid volume can be back-calculated by means of a microcontroller using calibration parameters. In cases where a sensor's electric-fields extend into neighboring channels, an EMI shield may be used to prevent channel-to-channel interference.

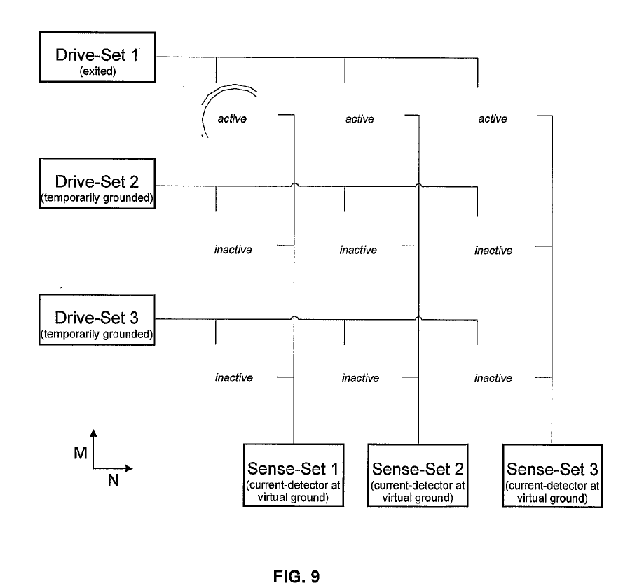

FIG. 9 illustrates a continuous-electrode design where M=3 sets of continuous electrodes (“drive-sets”) couple to N=3 sets of continuous sense-electrodes (“sense-sets”). Each set is independently operated. A single drive-set is excited while the remaining drive-sets are connected to a constant voltage (e.g., ground). The capacitance between the excited drive-set and each sense-set is then determined using N independent transducers. When the transducers are implemented using operational amplifiers configured as current-detectors, these will experience a current

$${i}_{N} = {C}_{M , N} \frac{d {v}_{M , N}}{d t} \qquad Equation 6$$

where i_{N} is the current in the sense-set electrode, C_{M,N} is the capacitance between drive-set M and sense-set N, and v_{M,N} is the voltage between drive-set M and sense-set N. C_{M,N} is dominated by capacitive-effects in the vicinity of the “intersection” of the excited drive-set M and sense-set N. Current i_{N} may therefore be used to transduce capacitance for implementing a sensor. Note that while the QT300 capacitance transducer is not an appropriate transducer for this electrode-configuration (as it would integrate capacitance to ground across the drive-set), a stray-immune charge-transfer capacitance transducer (see Section 4.4) would be appropriate. In addition, electrodes should be tightly coupled to minimize inter-sensor interference and/or the sensor array should include internal shielding (e.g., grounded conductors in the inter-sensor space) to prevent interference.

### 4.2 Arbitrarily-Arranged Sensors

No limitations are implied on the layout of the sensors forming the sensor array. The electrode geometry of the sensor array is not restricted to M×N formats used on standard multi-channel microplates or any other particular format. The density of the array geometry may also be increased until manufacturing capabilities and/or sensor performance limit its use.

### 4.3 Targeted and Simultaneous-Sampling of Sensors

The host controller may be programmed to repeatedly excite a single sensor, to sequentially excite a subset of sensors within the array, to sequentially excite the entire array, or to sequentially excite any conceivable subset of sensors best-suited to a particular application. This flexibility improves the efficiency of the device and increases the frequency at which the liquid level data is updated.

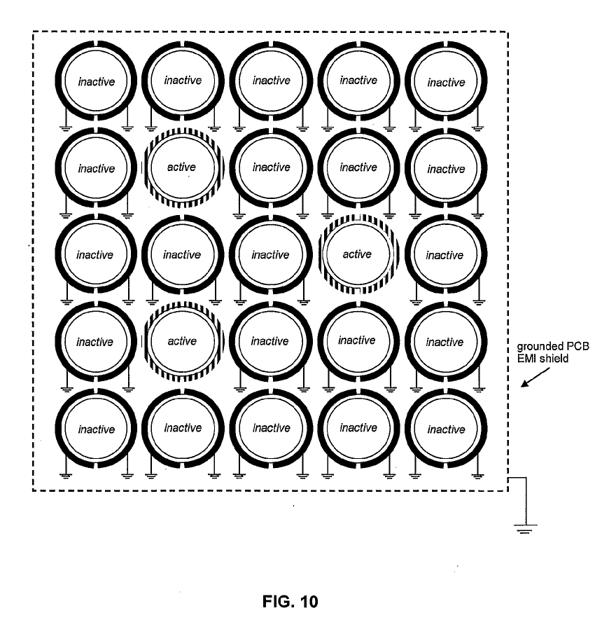

In addition, the simultaneous operation of multiple sensors is possible in arrays that are subdivided into electrically-isolated subsections. An active sensor surrounded by a perimeter of inactive electrodes constitutes an electrically-isolated subsection operating simultaneously with, but independent of, the active sensors in other subsections of the array. FIG. 10 shows an isolated subsection comprising three simultaneously-active sensors, each shielded by inactive neighboring sensors. Isolated subsections may also be dynamically defined by the host controller and tailored to specific applications. The simultaneous operation of multiple, electrically-isolated sensors increases the rate at which liquid-level data is updated across an array.

These concepts can be combined and/or extended to a large number of conceptually-equivalent configurations. Shielding need not be implemented using the grounded electrodes of inactive neighboring sensors; an electrical conductor held at some arbitrary voltage will suffice.

### 4.4 Substitution of the Capacitance Transducer

The sensor array can be adapted to employ a number of different capacitance transducers. For example, use of a frequency-domain capacitance transducer (Stott et al. 1985) is feasible and would permit for the simultaneous transduction of both capacitance and conductivity.

Another example is the use of a “stray-immune” charge-transfer capacitance transducer (Huang 1986); this transducer has the benefit of a lower baseline capacitance and a lower baseline drift that may improve the performance of the sensor. FIG. 7 shows the sources of capacitance contributing to the overall measurement made by the non stray-immune QT300 transducer. The measured capacitance, Cₘ, is the sum of C_{gnd2}, C_{gnd3}, C_{gnd4} and Cₓ. The transduction of liquid-levels concerns changes in Cₓ only, which the QT300 does not distinguish from variations in C_{gnd2}, C_{gnd3}, or C_{gnd4}.

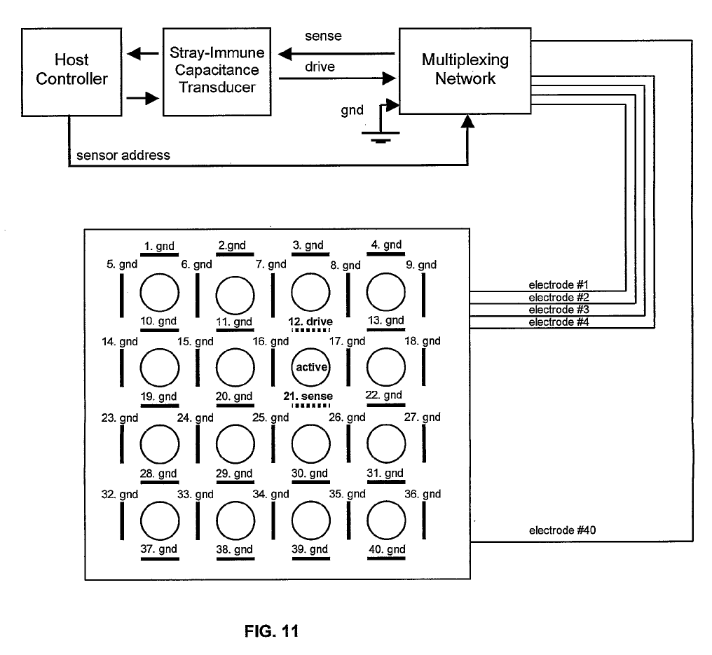

A stray-immune transducer is sensitive to Cₓ only, therefore reducing the variability in the system to improve performance. The baseline capacitance measured by the stray-immune is also lower which decreases the sampling time and improves the resolution of the charge-transfer transducer. FIG. 11 is a schematic of a sensor array that employs a single, stray-immune transducer interfaced to an array of individually-addressable electrodes. Note that use of a stray-immune capacitance transducer in combination with independent, individually-addressable electrodes, will eliminate the need for the duplication of electrodes in the inter-sensor space (see Section 4.5).

### 4.5 Multiplexed Electrodes

The hardware requirements for the sensor array could be reduced by employing a single capacitance transducer in combination with a multiplexing circuit for addressing independent, individually-addressable electrodes. The multiplexer sequentially connects the transducer to the sensors while the surrounding electrodes are multiplexed to ground to provide EMI shielding. FIG. 11 shows a possible implementation in combination with a stray-immune capacitance transducer. Note that in this case the duplication of electrodes in the inter-sensor space is unnecessary. This eliminates the need for duplication of electrodes in the inter-sensor space and permits larger sensor cavity volumes.

### 4.6 Conductivity Transducers

The utility of the sensor array can be expanded by including the flexibility of selecting between a capacitance transducer and a conductance transducer. Conductance measurements could be used to substantiate data from the capacitance measurements or to provide additional information relating to chemical or biological reactions.

It is also feasible to employ a dual capacitance/conductance transducer. For example, a frequency-based sinusoid-based transducer measuring complex impedance may be used to determine the real and the imaginary components of the impedance of the channel. A host-controller would subsequently back-calculate capacitance and conductance from these measurements. Any deterministic component of the measurement signal can be related to liquid level once the parameters describing the relationship to the physical property is identified. It is also conceivable that a fully characterized relationship between the output signal and liquid level, liquid permittivity and liquid conductivity will allow for a simplified calibration procedure where extrapolations are made from the measurements of a stock solution. This shortens the setup time required for calibration-dependent applications.

4.7 Microplate-Incorporated Sensor versus Sleeve Design

Integrating the sensor array with a standard multi-channel microplate can be achieved in a number of ways. For example, a scaled-up version of the sensor array could be integrated with a modified 96-channel microplate by adapting the sensor to serve as a docking platform. The microplate would comprise a matrix of uniform tubes built from a chemically inert insulator (e.g., polypropylene or Teflon), and would be designed to fit to the sensor platform. The modified microplate would serve as a disposable sleeve that contains the liquid and is manipulated by the automation. The sensor array supporting the microplate would have to be hermetically sealed to protect it from chemical reagents and dirt, and allow for its cleaning.

Another possibility is to develop a microplate design where the sensor electrodes are integrated within the walls of the microplate itself. For example, a PCB-based design could be employed with polypropylene molds fitted to the sensor array at the end of the fabrication process. Sensor electrodes, transducer electronics and inter-channel shielding would be implemented on the PCB, as well as a means for feedback (e.g., a cable port or wireless hardware) to the host controller of an automated platform.

Note that the modifications/enhancements presented in the preceding sections can be implemented and/or combined using a number of conceptually-equivalent implementations.

1. A method of measuring properties of a liquid contained in individual wells inside a multi-well array, the method comprising:
providing capacitor electrodes in said multi-well array, said electrodes adapted to detect a capacitance value of each one of said individual wells without interference of neighboring wells;
measuring a capacitance inside each one of said individual wells; and
using said capacitance measurements to calculate at least one property of said liquid contained in each one of said individual wells.

2. A method as claimed in claim 1, wherein said capacitor electrodes are rectangular-shaped, and said interference shielding of neighboring wells is carried out by connecting electrodes of said neighboring wells to ground or to common.

3. A method as claimed in claim 1, wherein said interference shielding of neighboring wells is carried out by using curve-shaped capacitor electrodes, where said capacitor electrodes enclose partially around said individual wells.

4. A method as claimed in claim 1, wherein said measuring comprises measuring calibration parameters of said individual wells.

5. A method as claimed in claim 1, wherein said measuring calibration parameters comprises measuring capacitance values of a given individual well at two different liquid volumes.

6. A method as claimed in claim 5, wherein said two different liquid volumes are when said given individual well is empty and when said given individual well is full with said liquid.

7. A method as claimed in claim 1, wherein said property is a volume of said liquid inside said individual wells, and said capacitance measuring is carried out using at least one of a dielectric constant and a conductivity of said liquid.

8. A method as claimed in claim 1, wherein said property is a state of presence of said liquid inside said individual wells,

9. A method as claimed in claim 1, wherein said property is a state of presence of a liquid chemical or biological reaction, and said measuring comprises measuring over time a value change in at least one of a dielectric constant and a conductivity of said liquid.

10. A method as claimed in claim 1, wherein said property is a change of volume of said liquid inside said individual wells, and said capacitance measuring is carried out using at least one of a dielectric constant and a conductivity of said liquid.

11. A method as claimed in claim 1, wherein said capacitor electrodes are ring electrodes, said measuring capacitance comprises measuring said capacitance during handling said liquid inside said individual wells and, during said handling, detecting at least one predetermined level between said ring electrodes when said capacitance reaches a threshold value.

12. A method of controlling quality of liquid handling task that is repeated across a set of individual wells inside a multi-well array, the method comprising:
performing a liquid handling task in at least two of said individual wells;
measuring capacitance of said at least two of said individual wells;
comparing said capacitance measurements to determine whether or not said measurements are consistent; and
using results of said comparison to determine whether or not said liquid handling task is consistent across said set of individual wells.

13. An apparatus for measuring properties of a liquid contained in individual wells inside a multi-well array, the apparatus comprising:
an array of individual wells;
a set of operationally-independent capacitive sensors having capacitor
electrodes shielding said individual wells; and
a capacitance-transducer to measure a capacitance of said individual wells.

14. An apparatus as claimed in claim 13, wherein each one of said individual wells is insulated with an insulating wall of a non-conductive bulk material.

15. An apparatus as claimed in claim 13, wherein said capacitor electrodes are rectangular-shaped plates and are designed to be connected to ground or to common to provide shielding.

16. An apparatus as claimed in claim 13, wherein said capacitor electrodes are curve-shaped plates and enclose partially around said individual wells to provide shielding.

17. An apparatus as claimed in claim 13, wherein said capacitor electrodes are ring electrodes.

18. An apparatus as claimed in claim 13, wherein said capacitor electrodes are continuous across said array of individual wells.

19. An apparatus as claimed in claim 13, wherein said multi-well array is one-dimensional.

20. An apparatus as claimed in claim 13, wherein said multi-well array is two-dimensional and consists of a multi-well plate.

21. An apparatus as claimed in claim 13, said apparatus further comprising:
a multiplexer connected to each one of said individual wells and to said transducer to respectively take control of a given individual well among said individual wells and to connect said given individual well to said capacitance-transducer to measure a capacitance of said given individual well; and
a control circuit connected to said multiplexer and to said capacitance-transducer to respectively transmit a control signal to said multiplexer to select said given individual well and to receive said capacitance value of said given individual well from said capacitive-transducer.

22. An apparatus as claimed in claim 21, wherein said capacitive sensors, said capacitive-transducer, said multiplexer and said control circuit are implemented on a single printed circuit board (PCB) yielding a compact design.

23. An apparatus as claimed in claim 22, wherein said PCB is constituted of four layers.
